(19) United States
(12) Patent Application Publication
(10) Pub. No.: US 2013/0315391 A1
(43) Pub. Date: Nov. 28, 2013

(54) SECURE COMMUNICATION SYSTEM AND COMMUNICATION APPARATUS

(71) Applicant: Oki Electric Industry Co., Ltd., Tokyo (JP)

(72) Inventors: Taketsugu YAO, Tokyo (JP); Kiyoshi FUKUI, Tokyo (JP)

(73) Assignee: OKI ELECTRIC INDUSTRY CO., LTD., Tokyo (JP)

(21) Appl. No.: 13/898,459

(22) Filed: May 20, 2013

(30) Foreign Application Priority Data
May 23, 2012 (JP) 2012-117649

(51) Int. Cl. H04L 29/06

(52) U.S. Cl. CPC H04L 63/0428
USPC 380/255

(57) ABSTRACT

There is provided a secure communication system comprising first and second communication apparatuses carrying out encrypted communication. The first communication apparatus includes: a first established communication path managing unit managing information on an encrypted communication path established with the second communication apparatus; and a first communication path reestablishing unit notifying the second communication apparatus of first communication apparatus identification information and operating with the second communication apparatus to reestablish an encrypted communication path using the information on the established encrypted communication path. The second communication apparatus includes: a second established communication path managing unit managing the first communication apparatus identification information and managing the information on the established encrypted communication path in association with the first communication apparatus identification information; and a second communication path reestablishing unit reestablishing the encrypted communication path based on the first communication apparatus identification information and the information on the established encrypted communication path.

### CROSS REFERENCE TO RELATED APPLICATION(S)

This application is based upon and claims benefit of priority from Japanese Patent Application No. 2012-117649, filed on May 23, 2012, the entire contents of which are incorporated herein by reference.

### BACKGROUND

The present invention relates to a secure communication system and a communication apparatus, such as a system and apparatus used when establishing and re-establishing an encrypted communication path.

To enable use of a sensor apparatus or the like with a function for communicating detected information in social infrastructure fields, such as disaster monitoring, traffic control, and finance, where high reliability and quality are necessary, it is necessary to maintain security for the communication between a communication apparatus such as a service providing server and a communication apparatus such as a sensor apparatus. In order for a communication apparatus such as a sensor apparatus to establish a secure end-to-end communication path with an unspecified communication apparatus such as a service providing server, it is necessary to have information exchanged on an end-to-end basis between the two communication apparatuses in the form of key exchanging, authentication, and setting the same encryption method.

Here, it would be conceivable for communication apparatuses such as sensor apparatuses to form a low-power multi-hop network. The expression “low-power multi-hop network” refers to a network where respective communication apparatuses such as sensor apparatuses distribute data according to a bucket relay method and where power consumption is suppressed by communication apparatuses sleeping when not involved in the distribution of data. As one example, when a huge number of communication apparatuses such as sensor apparatuses are spread out over a wide area and it is desirable to establish a secure end-to-end communication path between each of such communication apparatuses and a communication apparatus such as a server on the Internet, the end-to-end exchanging of information described above can cause problems such as congestion on the low-power multi-hop network, an increase in power consumption, and an increase in processing time.

As an existing method of dealing with the above problems, Japanese Laid-Open Patent Publication No. 2006-41726 proposes a method where an encrypted communication path establishment process for an end-to-end encrypted communication path which is necessary for IPsec (Security Architecture for Internet Protocol) or TLS (Transport Layer Security) is carried out by a home gateway apparatus as an agent so that an encrypted communication path can be provided securely and at high speed to an appliance, such as an Internet appliance, that has limited computational resources and memory resources. With the method disclosed in the cited publication, since processing is carried out by the home gateway apparatus that is present on a communication path between apparatuses inside and outside the home as an agent, it is possible for an apparatus in the home to have the encrypted communication path establishment process carried out by the agent without an apparatus outside the home being conscious of the presence of such agent.

### SUMMARY

However, with the technology in the cited publication, a home gateway apparatus that is a connection point between apparatuses inside and outside the home is regarded as an agent apparatus, and no consideration is given to the possibility of an appliance which is not present on the path between apparatuses inside and outside the home carrying out the above processing as an agent. As one example, with the spread of cloud services in recent years, it has become conceivable to consign only the encrypted communication path establishment process to a cloud server on the Internet instead of to a home gateway server. It is also possible to imagine cases where it will be difficult for an apparatus in the home to consign processing to a gateway apparatus, such as when the apparatus in the home and the gateway apparatus are provided by different vendors. In such cases, it is necessary to provide a framework where an apparatus inside the home can have an agent apparatus not present on a path between the apparatus inside the home and an apparatus outside the home carry out the establishment of an encrypted communication path with the apparatus outside the home as an agent.

Here, supposing that an agent apparatus has carried out the establishment of an encrypted communication path, if reestablishment of the encrypted communication path is then also consigned to the agent apparatus, a large amount of processing will be necessary for reestablishment. It is preferable for the communication function of a sensor apparatus to be as simple and inexpensive as possible, and if a sensor apparatus with such a communication function is one of the end apparatuses, the reestablishment of an encrypted communication path will presumably become necessary very often. In such situation, there is the risk of the large amount of processing necessary for reestablishment causing a large drop in the communication efficiency of the system.

For this reason, it would be desirable to provide a secure communication system and a communication apparatus capable of carrying out a reestablishment process for an end-to-end encrypted communication path at high speed while maintaining security.

According to a first aspect of the present invention, there is provided a secure communication system which includes a first communication apparatus and a second communication apparatus that carry out encrypted communication, wherein (1) the first communication apparatus includes (1-1) a first established encrypted communication path managing unit managing information relating to an encrypted communication path that has been established with the second communication apparatus, and (1-2) a first encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path, and (2) the second communication apparatus includes (2-1) a second established encrypted communication path managing unit managing the identification information unique to the first communication apparatus and managing the information relating to the established encrypted communication path in association with the identification information unique to the first communication apparatus, and (2-2) a second encrypted communication path reestablishing unit reestablishing the encrypted communication path with the first communication apparatus based on the identification information unique to the first communication apparatus and the information relating to the established encrypted communication path.

According to a second aspect of the present invention, there is provided a secure communication system which includes a first communication apparatus and a second communication apparatus that carry out encrypted communication, and a third communication apparatus that carries out a new establishment process for an encrypted communication path between the first communication apparatus and the second communication apparatus, as an agent of the first communication apparatus, wherein (1) the first communication apparatus includes (1-1) an established encrypted communication path information acquiring unit acquiring, from the third communication apparatus, information relating to an established encrypted communication path between the first communication apparatus and the second communication apparatus, already established by the third communication apparatus operating in cooperation with the second communication apparatus, (1-2) a first established encrypted communication path managing unit managing the information relating to the established encrypted communication path acquired by the established encrypted communication path information acquiring unit, and (1-3) a first encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path, (2) the second communication apparatus includes (2-1) a second established encrypted communication path managing unit managing information unique to the first communication apparatus that communicates with the second communication apparatus and managing information relating to the established encrypted communication path in association with the identification information unique to the first communication apparatus, and (2-2) a second encrypted communication path reestablishing unit reestablishing the encrypted communication path with the first communication apparatus based on the identification information unique to the first communication apparatus and the information relating to the established encrypted communication path, and (3) the third communication apparatus includes (3-1) an encrypted communication path establishment agent unit establishing the encrypted communication path between the first communication apparatus and the second communication apparatus as an agent of the first communication apparatus, including giving notification of the identification information unique to the first communication apparatus, and (3-2) an established encrypted communication path information notifying unit giving notification to the first communication apparatus of information relating to the established encrypted communication path.

According to a third aspect of the present invention, there is provided a communication apparatus carrying out encrypted communication via an encrypted communication path with another communication apparatus. The communication apparatus includes (1) an established encrypted communication path managing unit managing identification information unique to the other communication apparatus and managing information relating to an established encrypted communication path in association with the identification information unique to the other communication apparatus, and (2) an encrypted communication path reestablishing unit reestablishing an encrypted communication path with the other communication apparatus based on the identification information unique to the other communication apparatus and the information relating to the established encrypted communication path.

According to a forth aspect of the present invention, there is provided a first communication apparatus in a secure communication system including the first communication apparatus and a second communication apparatus that carry out encrypted communication, the system also including a third communication apparatus carrying out a new establishment process for an encrypted communication path between the first communication apparatus and the second communication apparatus as an agent of the first communication apparatus. The first communication apparatus includes (1) an established encrypted communication path information acquiring unit acquiring, from the third communication apparatus, information relating to an established encrypted communication path between the first communication apparatus and the second communication apparatus, already established by the third communication apparatus operating in cooperation with the second communication apparatus, (2) an established encrypted communication path managing unit managing the information relating to the established encrypted communication path acquired by the established encrypted communication path information acquiring unit, and (3) an encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path.

According to a fifth aspect of the present invention, there is provided a third communication apparatus in a secure communication system including the first communication apparatus and a second communication apparatus that carry out encrypted communication, where the third communication apparatus carries out a new establishment process for an encrypted communication path between the first communication apparatus and the second communication apparatus, as an agent of the first communication apparatus. The third communication apparatus includes (1) an encrypted communication path establishment agent unit establishing an encrypted communication path between the first communication apparatus and the second communication apparatus as an agent of the first communication apparatus, including giving notification of identification information unique to the first communication apparatus, and (2) an established encrypted communication path information notifying unit giving notification to the first communication apparatus of information relating to the established encrypted communication path.

According to the aspects of the present invention described above, it is possible to provide a secure communication system and a communication apparatus capable of carrying out a reestablishment process for an end-to-end encrypted communication path at high speed while maintaining security.

### BRIEF DESCRIPTION OF THE DRAWINGS

FIG. 1 is a block diagram showing the configuration of a secure communication system according to a first embodiment of the present invention;

FIG. 2 is a functional block diagram showing the internal configuration of two communication apparatuses according to the first embodiment;

FIG. 3 is a diagram useful in explaining a new establishment operation for an encrypted communication path between the two communication apparatuses according to the first embodiment;

FIG. 4 is a diagram useful in explaining an updating operation for information relating to an established encrypted communication path carried out by the two communication apparatuses according to the first embodiment;

FIG. 5 is a sequence chart showing the flow of a reestablishment operation for an encrypted communication path between the two communication apparatuses according to the first embodiment;

FIG. 6 is a diagram useful in explaining a reestablishment operation for an encrypted communication path between the two communication apparatuses according to the first embodiment;

FIG. 7 is a block diagram showing the configuration of a secure communication system according to a second embodiment of the present invention;

FIG. 8 is a functional block diagram showing the internal configuration of a first communication apparatus according to the second embodiment;

FIG. 9 is a functional block diagram showing the internal configuration of an agent apparatus according to the second embodiment;

FIG. 10 is a diagram useful in explaining a new establishment operation for an encrypted communication path between the two communication apparatuses according to the second embodiment;

FIG. 11 is a diagram useful in explaining an operation where the agent apparatus gives the first communication apparatus notification of information relating to an established encrypted communication path according to the second embodiment; and

FIG. 12 is a diagram useful in explaining a reestablishment operation for an encrypted communication path between two communication apparatuses in the second embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### (A) First Embodiment

A secure communication system and communication apparatus according to a first embodiment of the present invention will now be described with reference to the drawings.

The first embodiment is capable, even when the address on a network of one communication apparatus (the first communication apparatus described later) that is subject to communication has changed due to a handover or the like, of inheriting information relating to an end-to-end encrypted communication path that was already established before the change of address, making it possible to re-establish an encrypted communication path with less processing than when an encrypted communication path is newly constructed.

### (A-1) Configuration of First Embodiment

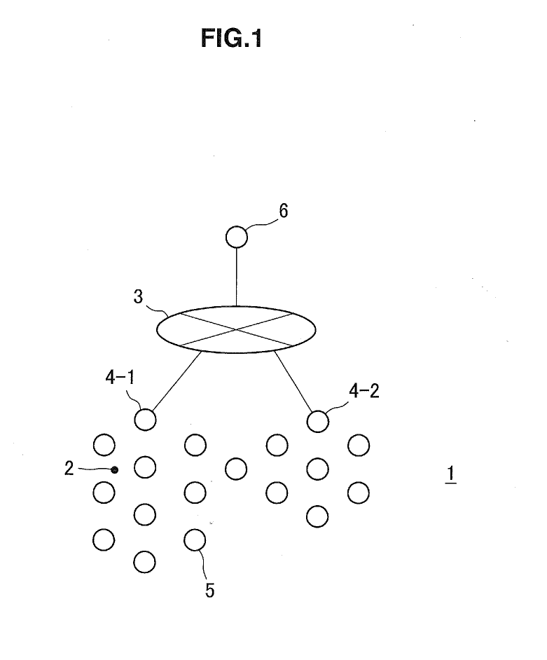

FIG. 1 is a block diagram showing a configuration of a secure communication system according to the first embodiment.

In FIG. 1, a secure communication system 1 according to the first embodiment includes a multi-hop network 2 and a wired network (referred to as the “IP network” in the explanation of the operation given later) 3, with a plurality of (in the example in FIG. 1, two) gateway apparatuses (hereinafter referred to as “first” and “second” gateway apparatuses) 4-1, 4-2 provided between the two networks 2 and 3. On the multi-hop network 2, a large number of communication apparatuses are spread out over a wide area, for example, and the wired network 3 includes a plurality of communication apparatuses. The first embodiment imagines end-to-end communication between a given communication apparatus (hereinafter referred to as the “first communication apparatus”) 5 on the multi-hop network 2 and a given communication apparatus (hereinafter referred to as the “second communication apparatus”) 6 that belongs to the wired network 3. Note that the network referred to as the wired network 3 may be partly or entirely constructed of a wireless network.

The secure communication system 1 according to the first embodiment is not limited to being applied to the above networks. As one example, a secure communication system that includes sensor apparatuses that form the low-power multi-hop network and a server apparatus (information gathering apparatus) on the Internet that gathers information from the sensor apparatuses is capable of being used as the secure communication system 1 of the first embodiment, and in such case, the first communication apparatus 5 is a sensor apparatus and the second communication apparatus 6 is a server apparatus on the Internet.

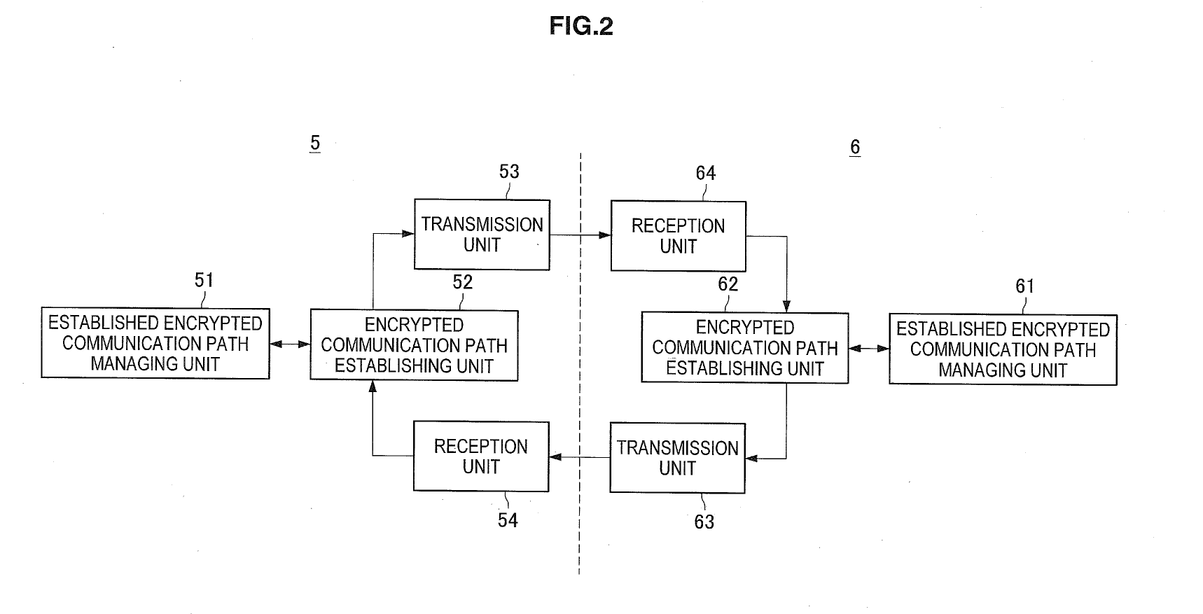

FIG. 2 is a functional block diagram showing the internal configuration of the first communication apparatus 5 and the second communication apparatus 6 according to the first embodiment.

Although the multi-hop network 2, the gateway apparatuses 4-1, 4-2, and the wired network 3 are interposed between the first communication apparatus 5 and the second communication apparatus 6 as described above, the interposed component elements are omitted from FIG. 2. Also, although all or a majority of the internal configuration (the configuration on a higher level than the physical level) of the first communication apparatus 5 and the second communication apparatus 6 is capable of being realized by software executed by a CPU, such structural elements can also be realized by electronic circuits such as a DSP (Digital Signal Processor), an ASIC (Application Specific IC), or a PLD (Programmable Logic Device), with such elements being functionally expressed by FIG. 2.

Although either of the first communication apparatus 5 and the second communication apparatus 6 may be an activation-side apparatus that establishes or re-establishes an encrypted communication path, the functions of the respective structural elements of the first communication apparatus 5 and the second communication apparatus 6 are described below with the first communication apparatus 5 as the activation-side apparatus that establishes or re-establishes an encrypted communication path and the second communication apparatus 6 as an apparatus that operates in response to such operations.

In the present specification, the expression “establishment (new establishment or reestablishment) of an encrypted communication path” refers to setting two communication apparatuses (the first communication apparatus 5, 5A and the second communication apparatus 6, 6A) that are to carry out communication in a state where encryption communication can be carried out between the apparatuses and does not include settings or the like of a path provided for communication between the two communication apparatus. Since the setting of a path departs from the characteristics of the respective embodiments, description thereof is omitted here. As one example, to establish an encrypted communication path, it is necessary to authenticate that both communication apparatuses are capable of encrypted communication, to share the information that enables encrypted communication to be carried out (such as deciding the encryption algorithm and/or hash algorithm to be used), and/or to exchange information that enables encrypted communication to be carried out (such as exchanging and sharing keys, master secrets, and the like).

In FIG. 2, the first communication apparatus 5 includes an established encrypted communication path managing unit 51, an encrypted communication path establishing unit 52, a transmission unit 53, and a reception unit 54.

The established encrypted communication path managing unit 51 manages information relating to an encrypted communication path that is already established between the first communication apparatus 5 and the second communication apparatus 6. The expression “information relating to the encrypted communication path” is information such as an encryption algorithm or encryption method to be used for secure communication between the first communication apparatus 5 and the second communication apparatus 6, key information to be used, or identification information for identifying such apparatuses, or a plurality of such information. As one example, the information relating to the encrypted communication path may include a session ID and/or a master secret that is/are shared as the result of a handshake process that uses TLS. As another example, the information relating to the encrypted communication path may include a shared secret key that is shared the result of a secure association process that uses IPsec. The established encrypted communication path managing unit 51 receives information relating to a newly established encrypted communication path from the encrypted communication path establishing unit 52 and manages the received information relating to the encrypted communication path as information relating to an established encrypted communication path. The established encrypted communication path managing unit 51 also provides information relating to an established encrypted communication path already managed by the established encrypted communication path managing unit 51 to the encrypted communication path establishing unit 52.

The encrypted communication path establishing unit 52 newly establishes or reestablishes an encrypted communication path with the second communication apparatus 6. As the method of establishing an encrypted communication path, it is possible to use TLS or IPsec, for example. Here, the present invention is not especially limited to a key exchanging method, authentication method, or encryption method that uses TLS or IPsec. As examples, authentication and key exchanging may be realized by exchanging a certificate, or authentication and the sharing of an encryption key may be realized by using a secret key that is shared in advance. The encrypted communication path establishing unit 52 supplies a message for establishing an encrypted communication path with the second communication apparatus 6 to the transmission unit 53 and is supplied with a message for establishing an encrypted communication path from the reception unit 54.

By generating a request message for newly establishing an encrypted communication path to be sent to the second communication apparatus 6, the encrypted communication path establishing unit 52 newly establishes an encrypted communication path with the second communication apparatus 6. Here, the first communication apparatus 5 may notify the second communication apparatus 6 of identification information that is unique to the first communication apparatus 5 and is to be associated with information relating to the newly established encrypted communication path. Such identification information may be arbitrarily decided by the system 1 or, like a MAC address or the like, may be decided in advance for apparatuses on a higher level than the system 1. Here, the encrypted communication path establishing unit 52 supplies information relating to the encrypted communication path newly established with the second communication apparatus 6 to the established encrypted communication path managing unit 51.

Also, by generating a request message for reestablishing an encrypted communication path to be sent to the second communication apparatus 6 in accordance with the identification information that is unique to the first communication apparatus 5, the encrypted communication path establishing unit 52 reestablishes an encrypted communication path with less processing than when an encrypted communication path is newly established with the second communication apparatus 6. In this case, by being supplied with information relating to an encrypted communication path already established with the second communication apparatus 6 from the established encrypted communication path managing unit 51, the encrypted communication path establishing unit 52 re-establishes an encrypted communication path using the supplied information relating to the encrypted communication path. As one example, if an encrypted communication path is reestablished using TLS, a session ID of an already established encrypted communication path is included in an establishment request message. As another example, if an encrypted communication path is reestablished using IPsec, by using an ISAKMP (Internet Security Association and Key Management Protocol) security association that has already been established using a protocol (processing of phase 1 of IPsec) such as IKE (Internet Key Exchange), an IPsec security association (processing of phase 2) for an encrypted communication path is established.

The transmission unit 53 transmits a message for establishing an encrypted communication path supplied by the encrypted communication path establishing unit 52 to the second communication apparatus 6.

The reception unit 54 supplies a message for establishing the encrypted communication path received from the second communication apparatus 6 to the encrypted communication path establishing unit 52.

In the same way as the first communication apparatus 5, the internal configuration of the second communication apparatus 6 includes an established encrypted communication path managing unit 61, an encrypted communication path establishing unit 62, a transmission unit 63, and a reception unit 64. However, the functions of the respective structural elements of the second communication apparatus 6 differ to the functions of the corresponding structural elements of the first communication apparatus 5.

The established encrypted communication path managing unit 61 manages unique identification information of the first communication apparatus 5 and manages information relating to an encrypted communication path already established with the first communication apparatus 5 in association with the unique identification information of the first communication apparatus 5.

The established encrypted communication path managing unit 61 supplies information relating to an encrypted communication path associated with the identification information unique to the first communication apparatus 5 to the encrypted communication path establishing unit 62. Here, by being supplied with identification information that is unique to the first communication apparatus 5 from the encrypted communication path establishing unit 62, the established encrypted communication path managing unit 61 may provide information relating to an encrypted communication path managed in association with such identification information in reply. The established encrypted communication path managing unit 61 may supply all of the information relating to the already established encrypted communication paths to the encrypted communication path establishing unit 62.

Meanwhile, if identification information unique to a first communication apparatus and information relating to a newly established encrypted communication path are supplied from the encrypted communication path establishing unit 62, the established encrypted communication path managing unit 61 may update or add to the information relating to the encrypted communication path associated with the identification information unique to the first communication apparatus described above out of the information relating to the encrypted communication paths managed by the established encrypted communication path managing unit 61.

The encrypted communication path establishing unit 62 newly establishes or reestablishes an encrypted communication path with the first communication apparatus 5. As the method of establishing an encrypted communication path, it is possible to use TLS or IPsec, for example. The encrypted communication path establishing unit 62 supplies a message for establishing an encrypted communication path with the first communication apparatus 5 to the transmission unit 63 and is supplied with a message for establishing an encrypted communication path from the reception unit 64.

By being supplied with a request message for new establishment of an encrypted communication path from the first communication apparatus 5, the encrypted communication path establishing unit 62 newly establishes an encrypted communication path with the first communication apparatus 5. The encrypted communication path establishing unit 62 supplies information relating to the encrypted communication path newly established with the first communication apparatus 5 and identification information that is unique to the first communication apparatus notified from the first communication apparatus 5 to the established encrypted communication path managing unit 61. By being supplied with identification information that is unique to the first communication apparatus and a request message for reestablishment of an encrypted communication path, the encrypted communication path establishing unit 62 reestablishes an encrypted communication path with less processing than when an encrypted communication path with the first communication apparatus 5 is newly established. In this case, by using information relating to an already established encrypted communication path associated with the identification information that is unique to the first communication apparatus and has been supplied from the established encrypted communication path managing unit 61, the encrypted communication path establishing unit 62 reestablishes an encrypted communication path. As one example, when an encrypted communication path is reestablished using TLS, if a session ID included in the re-establishment request message is the same as a session ID of an established encrypted communication path associated with identification information that is unique to the first communication apparatus, information relating to such encrypted communication path is used to reestablish an encrypted communication path with the first communication apparatus 5. As another example, when an encrypted communication path is reestablished using IPsec, if the security association used in the reestablishment request is the same as the security association of an established encrypted communication path associated with identification information that is unique to the first communication apparatus 5, information relating to such encrypted communication path is used to reestablish an encrypted communication path with the first communication apparatus 5.

The transmission unit 63 transmits a message for establishing an encrypted communication path supplied from the encrypted communication path establishing unit 62 to the first communication apparatus 5.

The reception unit 64 supplies a message for establishing an encrypted communication path received from the first communication apparatus 5 to the encrypted communication path establishing unit 62.

### (A-2) Operation of the First Embodiment

Next, the operation of the secure communication system 1 according to the first embodiment will be described with reference to the drawings in the following order: new establishment operation for an encrypted communication path; information updating operation for information relating to an established encrypted communication path; and reestablishment operation for an encrypted communication path. In particular, the reestablishment operation for an encrypted communication path that is characteristic to the first embodiment will be described in detail.

### (A-2-1) New Establishment Operation for an Encrypted Communication Path

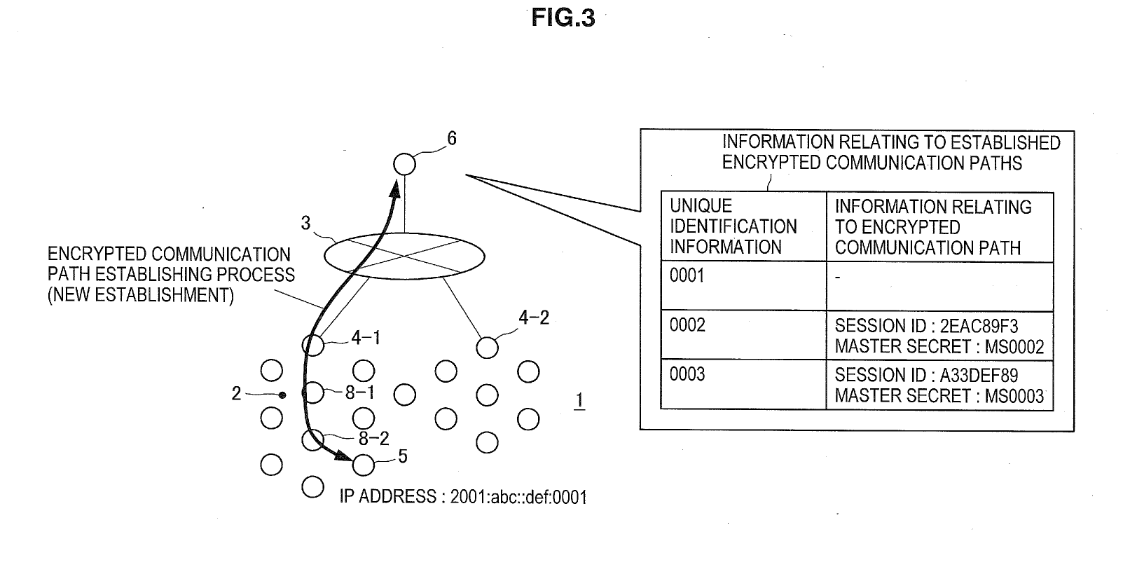

First, a new establishment operation for an encrypted communication path between the first communication apparatus 5 and the second communication apparatus 6 will be described with reference to FIG. 3.

Note that before the new establishment operation is carried out, information relating to an encrypted communication path with the first communication apparatus 5 is not written in the information relating to established encrypted communication paths managed by the established encrypted communication path managing unit 61 of the second communication apparatus 6. FIG. 3 shows a case where the identification information unique to the first communication apparatus 5 is “0001”. Also, the second communication apparatus 6 corresponds for example to a server on the Internet and is capable of secure communication with a plurality of communication apparatuses in parallel.

When communication (encrypted communication) with the second communication apparatus 6 becomes necessary, the first communication apparatus 5 connects to the wired network 3 via a gateway apparatus (assumed here to be the first gateway apparatus 4-1) and acquires an IP address (for example “2001:abc::def:0001”). For example, the first communication apparatus 5 internally stores information that assigns a priority order to a plurality of gateway apparatuses and decides the gateway apparatus to be used in accordance with such priority order information. The priority order information may be obtained during an operation that acquires information on nodes present in the periphery as nodes of the multi-hop network 2 (for example, the priority order of gateway apparatuses with a low number of hops is set higher) or may be set in advance by a setting operation by an operator when the first communication apparatus 5 is set as a node on the multi-hop network 2. As another example, it is also possible to search for the gateway apparatus to be used when an IP address is acquired. Although an example where an IP address is acquired from (a NAT apparatus on) the wired network 3 is described above, the first gateway apparatus 4-1 may store IP addresses that can be assigned to nodes on the multi-hop network 2 in advance and assign one of such IP addresses to the first communication apparatus 5.

After this, in the first communication apparatus 5, the encrypted communication path establishing unit 52 generates a new encrypted communication path establishment request for the second communication apparatus 6 and transmits the request via the transmission unit 53 to the second communication apparatus 6. The encrypted communication path establishment request may have a different or the same composition (of packets or the like) on the multi-hop network 2 and on the wired network 3, and if in the former case where the composition is different, the first gateway apparatus 4-1 carries out conversion and the like of the packet composition. An transmitter IP address may be included in a packet of an encrypted communication path establishment request that reaches the second communication apparatus 6 and the second communication apparatus 6 communicates with the first communication apparatus 5 with the IP address described above as the IP address of the first communication apparatus 5. Other communication apparatuses 8-1, 8-2 on the multi-hop network 2 that are present on a communication path between the first communication apparatus 5 and the second communication apparatus 6 are decided according to an existing path deciding method. Since a method of deciding the path departs from the characteristics of the respective embodiments, description thereof is omitted here.

With reception of the encrypted communication path establishment request at the second communication apparatus 6 as a trigger, the encrypted communication path establishing unit 52 of the first communication apparatus 5 and the encrypted communication path establishing unit 62 of the second communication apparatus 6 act cooperatively to carry out an establishment process for an encrypted communication path between the first communication apparatus 5 and the second communication apparatus 6. Here, the encrypted communication path establishing unit 52 of the first communication apparatus 5 establishes an encrypted communication path by notifying the second communication apparatus 6 of identification information that is unique to the first communication apparatus.

### (A-2-2) Updating Operation for Information Relating to an Established Encrypted Communication Path

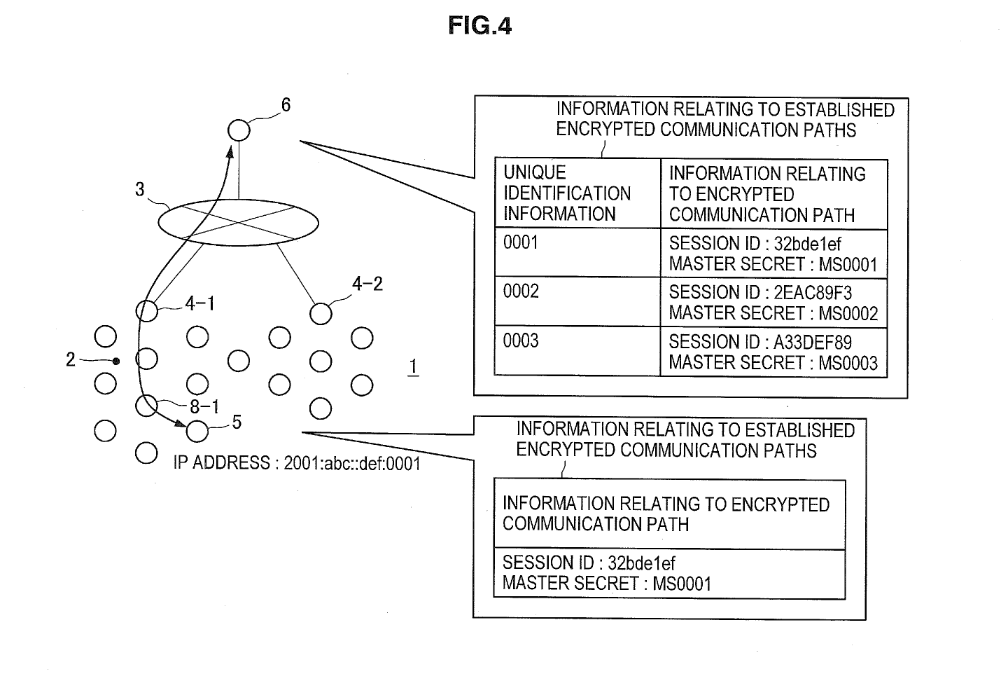

Next, an operation that updates information relating to an established encrypted communication path carried out by the first communication apparatus 5 and the second communication apparatus 6 will be described with reference to FIG. 4.

When an encrypted communication path with the second communication apparatus 6 has been established, the established encrypted communication path managing unit 51 of the first communication apparatus 5 manages information relating to the established encrypted communication path. Also, when an encrypted communication path with the first communication apparatus 5 has been established, the established encrypted communication path managing unit 61 of the second communication apparatus 6 manages the identification information unique to the first communication apparatus in association with the information relating to the encrypted communication path established with the first communication apparatus 5.

FIG. 4 shows an example where TLS is used as the method of establishing an encrypted communication path. The established encrypted communication path managing unit 51 of the first communication apparatus 5 manages a session ID “32bde1ef” and a master secret “MS0001” that are shared as the result of a handshake process. The established encrypted communication path managing unit 61 of the second communication apparatus 6 also manages a session ID “32bde1ef”, a master secret “MS0001”, and the like that are the same as the first communication apparatus 5 side in association with the identification information “0001” that is unique to the first communication apparatus 5.

### (A-2-3) Reestablishment Operation for an Encrypted Communication Path

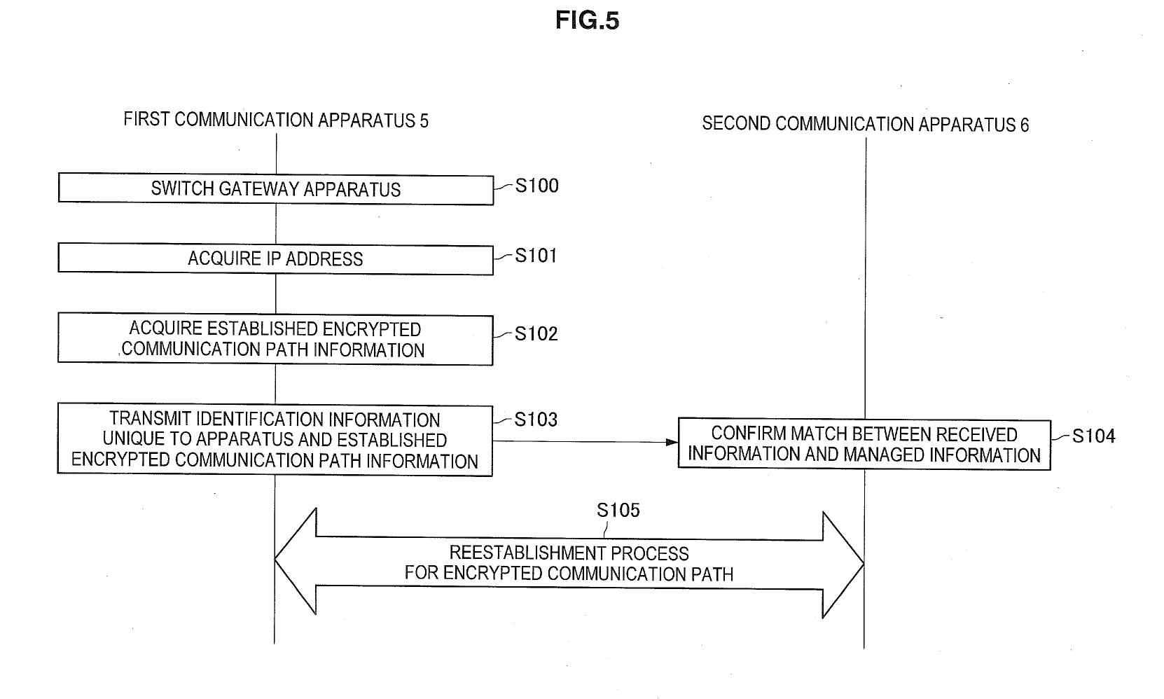

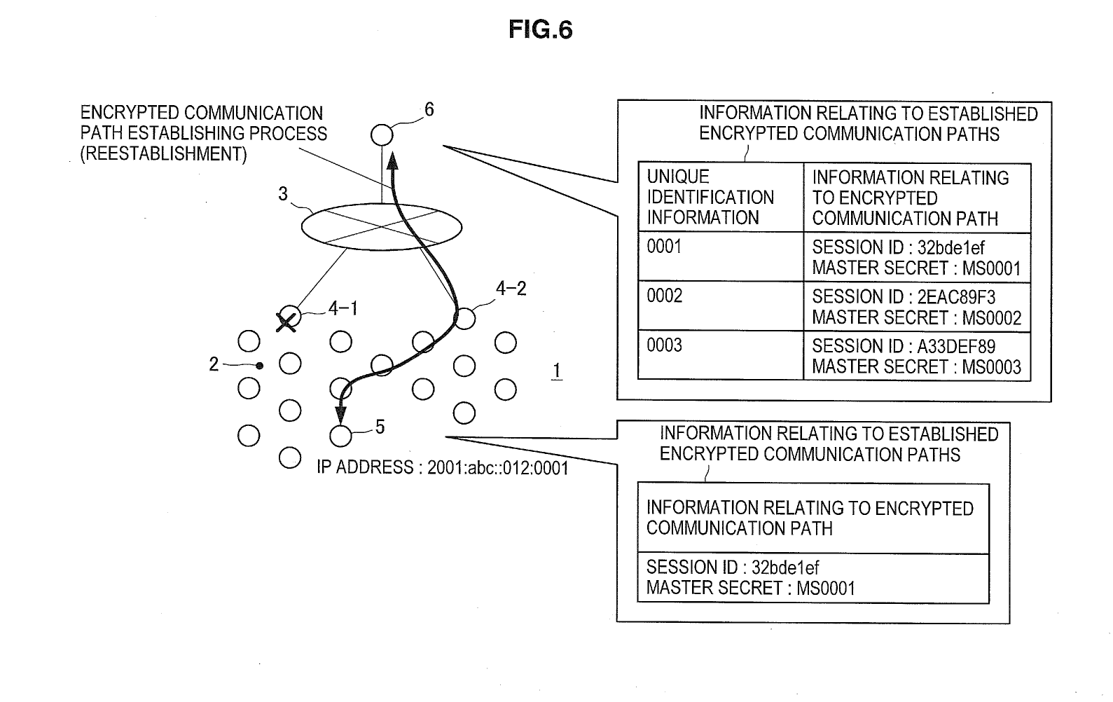

Next, a reestablishment operation for an encrypted communication path between the first communication apparatus 5 and the second communication apparatus 6 will be described with reference to FIG. 5 and FIG. 6. FIG. 5 is a sequence chart showing the flow of the reestablishment operation and FIG. 6 is a diagram useful in explaining an image of the reestablishment operation.

On detecting that it is not possible to connect via the first gateway apparatus 4-1 to the wired network 3, the first communication apparatus 5 starts a reestablishment operation for an encrypted communication path and switches the gateway apparatus to which the first communication apparatus 5 connects from the first gateway apparatus 4-1 to the second gateway apparatus 4-2 (step S100). The first communication apparatus 5 then connects via the second gateway apparatus 4-2 to the wired network 3 and acquires an IP address (for example “2001:abc::012:0001”) (step S101).

The encrypted communication path establishing unit 52 of the first communication apparatus 5 acquires information (the session ID “32bde1ef”, the master secret “MS0001”, and the like) relating to the encrypted communication path already established with the second communication apparatus 6 from the established encrypted communication path managing unit 51 (step S102).

The encrypted communication path establishing unit 52 of the first communication apparatus 5 generates a reestablishment request for the encrypted communication path with the second communication apparatus 6 that includes the identification information (0001) that is unique to the first communication apparatus and information (the session ID “32bde1ef”, the master secret “MS0001”, and the like) relating to the encrypted communication path already established with the second communication apparatus 6, and transmits the reestablishment request via the transmission unit 53 to the second communication apparatus 6 (step S103).

When the second communication apparatus 6 has received a reestablishment request for an encrypted communication path using the reception unit 64, the encrypted communication path establishing unit 62 acquires, from the established encrypted communication path managing unit 61 and based on the identification information (0001) that is unique to the first communication apparatus included in the reestablishment request for an encrypted communication path, information relating to an encrypted communication path that has already been established with first communication apparatus 5 and is associated with the identification information (0001) that is unique to the first communication apparatus, and then confirms whether the received information relating to the encrypted communication path matches the information relating to the encrypted communication path acquired from the established encrypted communication path managing unit 61 (step S104).

After this, a reestablishment process for an encrypted communication path is carried out between the encrypted communication path establishing unit 62 of the second communication apparatus 6 and the encrypted communication path establishing unit 52 of the first communication apparatus 5 (step S105). In this reestablishment process for an encrypted communication path, unlike the new establishment process, the communication process for sharing information relating to the encrypted communication path (for example, the session ID “32bde1ef” and the master secret “MS0001”) between the first communication apparatus 5 and the second communication apparatus 6 is omitted.

As one example, if an encrypted communication path is reestablished using TLS, out of the transmission and reception of communication messages in accordance with a TLS handshake protocol, the transmission and reception of communication messages for sharing the master secret “MS0001” between the first communication apparatus 5 and the second communication apparatus 6 can be omitted and the encrypted communication path establishing unit 62 of the second communication apparatus 6 and the encrypted communication path establishing unit 52 of the first communication apparatus 5 omit the transmission and reception of such communication messages when reestablishing an encrypted communication path and instead continue to use the master secret managed by the established encrypted communication path managing units 61, 51 of such apparatuses. As another example, if an encrypted communication path is reestablished using IPsec, the encrypted communication path establishing unit 52 of the first communication apparatus 5 and the encrypted communication path establishing unit 62 of the second communication apparatus 6 omit the processing of phase 1, that is, IKE key exchanging, and instead the information relating to an encrypted communication path managed by the established encrypted communication path managing units 51, 61 of such apparatuses is used to carry out the processing in phase 2, that is, IPsec security association for an encrypted communication path.

Note that if the encrypted communication path establishing unit 62 of the second communication apparatus 6 is unable to confirm whether the received information relating to an encrypted communication path and the information relating to the encrypted communication path acquired from the established encrypted communication path managing unit 61 match, the new establishment process for an encrypted communication path is carried out by the encrypted communication path establishing unit 62 of the second communication apparatus 6 and the encrypted communication path establishing unit 52 of the first communication apparatus 5.

### (A-3) Effect of the First Embodiment

According to the first embodiment, by managing identification information that is unique to the first communication apparatus in association with information relating to an encrypted communication path already established with the first communication apparatus 5, the second communication apparatus 6 is capable, when for example an obstacle has occurred on the path from the first communication apparatus 5 to the first gateway apparatus 4-1 and the first communication apparatus 5 has connected to the network via the second gateway apparatus 4-2 (as one example, when the address on the network of the first communication apparatus 5 has changed), of using, based on the identification information unique to the first communication apparatus, information relating to an encrypted communication path that has already been established by the first communication apparatus 5 and the second communication apparatus 6 to reestablish an encrypted communication path with less processing than when the first communication apparatus 5 newly establishes an encrypted communication path to the second communication apparatus 6.

The effect described above is especially advantageous for a network such as a low power multi-hop network.

As one example, if the second communication apparatus 6 is a server apparatus on the Internet, the first communication apparatus 5 is a mobile terminal such as a notebook PC, and the address on the network changes according to the access point (which corresponds to a gateway apparatus), an encrypted communication path will be newly established with the second communication apparatus 6 whenever a new address on the network is assigned to a first communication apparatus 5. Also, since there is a premise that a unspecified large number of terminals access a server apparatus on the Internet that corresponds to the second communication apparatus 6, it will become complex to manage unique identification information of such unspecified large number of terminals that connect to the second communication apparatus 6 and such management has limited advantages.

Meanwhile, on a low-power multi-hop network, as described earlier, using information relating to an encrypted communication path that has already been established is extremely effective in reducing the amount of communication required to reestablish an encrypted communication path. Also, on a low-power multi-hop network, since the first communication apparatus 5 differs to an apparatus used by a person such as a notebook PC and is an autonomous apparatus, such as a sensor apparatus, equipped with a communication function, it is believed that the second communication apparatus 6 that is the communication partner of the first communication apparatus 5 will be decided in advance or will be notified from another apparatus. This means that from the viewpoint of the second communication apparatus 6, it is possible to manage the first communication apparatuses 5 connected to such second communication apparatus 6. In this way, a low-power multi-hop network has a premise that the second communication apparatus 6 will be accessed from specified first communication apparatuses 5. By managing, at the second communication apparatus 6, such specified first communication apparatuses 5 and managing information relating to encrypted communication paths already established with such first communication apparatuses in association with the identification information unique to such first communication apparatuses 5, the effect of being able to reestablish an encrypted communication path while reducing the amount of communication between the first communication apparatus 5 and the second communication apparatus 6 even when a secure connection between the first communication apparatus 5 and the second communication apparatus 6 has been lost and/or the address on the network of the first communication apparatus 5 has changed is especially large.

### (B) Second Embodiment

Next, a secure communication system and communication apparatus according to a second embodiment of the present invention will be described with reference to the drawings.

In this second embodiment, by having an agent apparatus carry out a new establishment process for an encrypted communication path between the first communication apparatus and the second communication apparatus and having the first communication apparatus receive information relating to the encrypted communication path from the agent apparatus, it is possible to later reestablish an encrypted communication path with less processing than when an encrypted communication path is newly established.

### (B-1) Configuration of the Second Embodiment

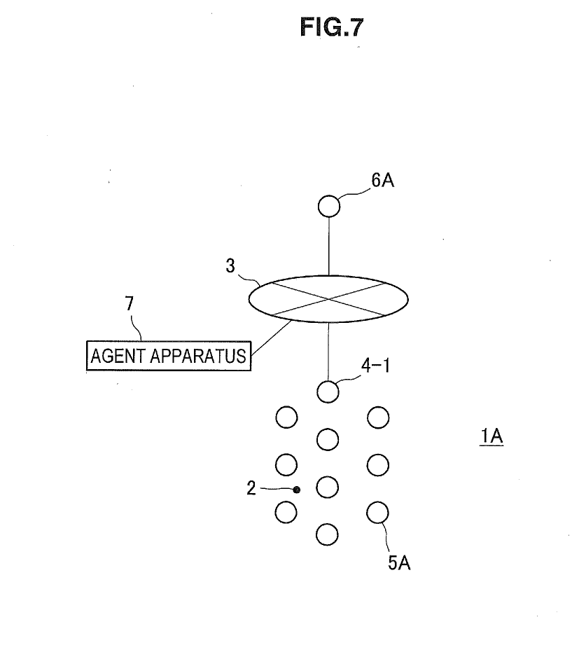

FIG. 7 is a block diagram showing the configuration of a secure communication system according to a second embodiment.

In FIG. 7, a secure communication system 1A according to the second embodiment includes an agent apparatus 7 in addition to the structural elements of the secure communication system 1 according to the first embodiment. Note that such agent apparatus is expressed as a “third communication apparatus” in the range of the patent claims. Note also that the agent apparatus 7 may be constructed as a dedicated apparatus or that a gateway apparatus, an SIP proxy apparatus, or the like may be further equipped with a function as an agent apparatus for this second embodiment. Also, although FIG. 7 shows an example where the agent apparatus 7 is provided on the wired network 3, such agent apparatus 7 may be provided on the multi-hop network 2.

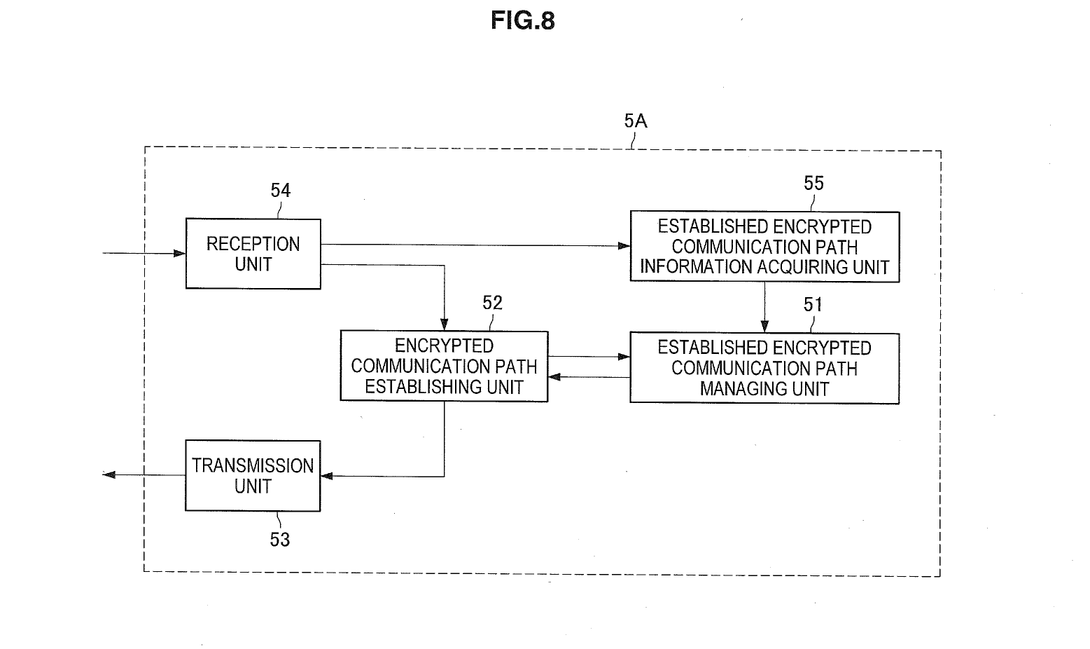

FIG. 8 is a functional block diagram showing the internal configuration of a first communication apparatus 5A according to the second embodiment. Parts that are the same or correspond to FIG. 2 described above in the first embodiment have been assigned the same reference numerals.

In FIG. 8, the first communication apparatus 5A includes an established encrypted communication path information acquiring unit 55, the established encrypted communication path managing unit 51, the encrypted communication path establishing unit 52, the transmission unit 53, and the reception unit 54. Out of such elements, since the encrypted communication path establishing unit 52 and the transmission unit 53 are the same as the corresponding structural elements in the first embodiment, description thereof is omitted.

The established encrypted communication path information acquiring unit 55 acquires information relating to a new encrypted communication path between the first communication apparatus 5A and the second communication apparatus 6A established by the agent apparatus 7 with the second communication apparatus 6A as an agent for the first communication apparatus 5A. The established encrypted communication path information acquiring unit 55 may acquire the information relating to the encrypted communication path securely from the agent apparatus 7. For example, encryption and authentication may be carried out using a secret key shared by the agent apparatus 7 and the second communication apparatus 6A. The established encrypted communication path information acquiring unit 55 acquires information relating to the encrypted communication path provided via the reception unit 54 and gives the acquired information to the established encrypted communication path managing unit 51.

Aside from managing information relating to the encrypted communication path that the agent apparatus 7 has newly established with the second communication apparatus 6A, the established encrypted communication path managing unit 51 is the same as the established encrypted communication path managing unit 51 in the first embodiment.

Aside from supplying the information relating to the new encrypted communication path with the second communication apparatus 6A received from the agent apparatus 7 to the established encrypted communication path information acquiring unit 55, the reception unit 54 is the same as the reception unit 54 of the first communication apparatus 5 in the first embodiment.

In the same way as the second communication apparatus 6 in the first embodiment, the second communication apparatus 6A in the second embodiment includes the established encrypted communication path managing unit 61, the encrypted communication path establishing unit 62, the transmission unit 63, and the reception unit 64.

Aside from being supplied from the encrypted communication path establishing unit 62 with identification information unique to a first communication apparatus and information relating to the encrypted communication path between communication apparatuses newly established with the agent apparatus 7 associated with the identification information unique to the first communication apparatus, the established encrypted communication path managing unit 61 is the same as the established encrypted communication path managing unit 61 in the first embodiment.

Although the encrypted communication path establishing unit 62 is substantially the same as the encrypted communication path establishing unit 62, the other apparatus with which an establishment operation is carried out differs to the first embodiment. The encrypted communication path establishing unit 62 newly establishes an encrypted communication path for use with the first communication apparatus 5A by operating together with the agent apparatus 7.

By receiving a request message for new establishment of an encrypted communication path from the agent apparatus 7, the encrypted communication path establishing unit 62 newly establishes an encrypted communication path for use with the first communication apparatus 5A by operating in cooperation with the agent apparatus 7. The encrypted communication path establishing unit 62 supplies the information relating to the encrypted communication path newly established with the agent apparatus 7 and the identification information that is unique to the first communication apparatus and has been notified from the agent apparatus 7 to the established encrypted communication path managing unit 61. Note that with the second embodiment, the encrypted communication path establishing unit 62 carries out the transmission and reception of messages for reestablishing an encrypted communication path with the first communication apparatus 5A.

The transmission unit 63 transmits a message for establishing an encrypted communication path supplied from the encrypted communication path establishing unit 62 to the agent apparatus 7 or the first communication apparatus 5A.

The reception unit 64 supplies a message for establishing an encrypted communication path received from the agent apparatus 7 or the first communication apparatus 5A to the encrypted communication path establishing unit 62.

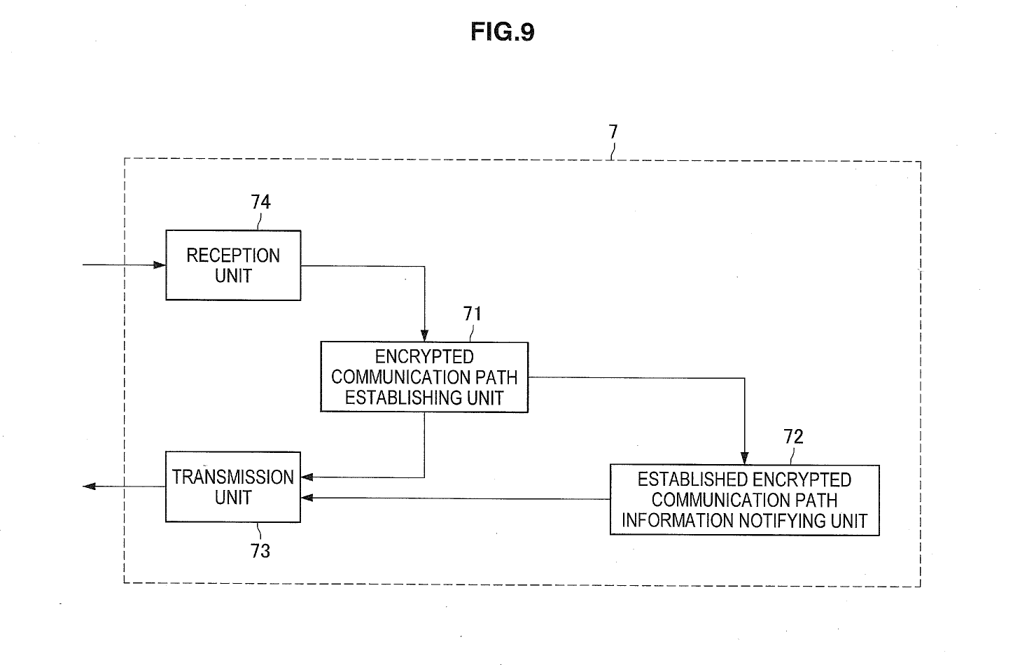

FIG. 9 is a functional block diagram showing the internal configuration of the agent apparatus 7 according to the second embodiment. Although all or a majority of the internal configuration (the configuration on a higher level than the physical level) of the agent apparatus 7 is capable of being realized by software executed by a CPU, such structural elements can also be realized by electronic circuits such as a DSP, an ASIC, or a PLD, with such elements being functionally expressed by FIG. 9.

In FIG. 9, the agent apparatus 7 includes an encrypted communication path establishing unit 71, an established encrypted communication path information notifying unit 72, a transmission unit 73, and a reception unit 74.

The encrypted communication path establishing unit 71 acts as an agent of the first communication apparatus 5A and newly establishes an encrypted communication path with the second communication apparatus 6A. By generating a request message for newly establishing an encrypted communication path with the second communication apparatus 6A, the encrypted communication path establishing unit 71 newly establishes an encrypted communication path with the second communication apparatus 6A. Here, the encrypted communication path establishing unit 71 notifies the second communication apparatus 6A of the identification information that is unique to the first communication apparatus and is to be associated with the information relating to the newly established encrypted communication path. The encrypted communication path establishing unit 71 supplies information relating to the encrypted communication path newly established between the first communication apparatus 5A and the second communication apparatus 6A to the established encrypted communication path information notifying unit 72.

The established encrypted communication path information notifying unit 72 notifies the first communication apparatus 5A of information relating to the encrypted communication path that has been newly established by the agent apparatus 7 acting as an agent of the first communication apparatus 5A. The established encrypted communication path information notifying unit 72 may securely notify the first communication apparatus 5A of the information relating to the newly established encrypted communication path. As one example, encryption and authentication may be carried out using a secret key shared by the agent apparatus 7 and the first communication apparatus 5A. The established encrypted communication path information notifying unit 72 supplies the information relating to the newly established encrypted communication path supplied from the encrypted communication path establishing unit 71 to the transmission unit 73.

The transmission unit 73 transmits a message for newly establishing an encrypted communication path supplied from the encrypted communication path establishing unit 71 to the second communication apparatus 6A. The transmission unit 73 also transmits the information relating to the encrypted communication path newly established for the first communication apparatus 5A and the second communication apparatus 6A provided from the established encrypted communication path information notifying unit 72 to the first communication apparatus 5A.

The reception unit 74 supplies a message for newly establishing an encrypted communication path received from the second communication apparatus 6A to the encrypted communication path establishing unit 71.

Note that although it is preferable for the agent apparatus 7 to communicate with the second communication apparatus 6A without passing via the first communication apparatus 5A, the agent apparatus 7 may communicate with the second communication apparatus 6A via the first communication apparatus 5A.

### (B-2) Operation of the Second Embodiment

Next, the operation of the secure communication system 1A according to the second embodiment will be described with reference to the drawings in the following order: new establishment operation for an encrypted communication path; notification operation for information relating to established encrypted communication path; and reestablishment operation for an encrypted communication path.

### (B-2-1) New Establishment Operation for an Encrypted Communication Path

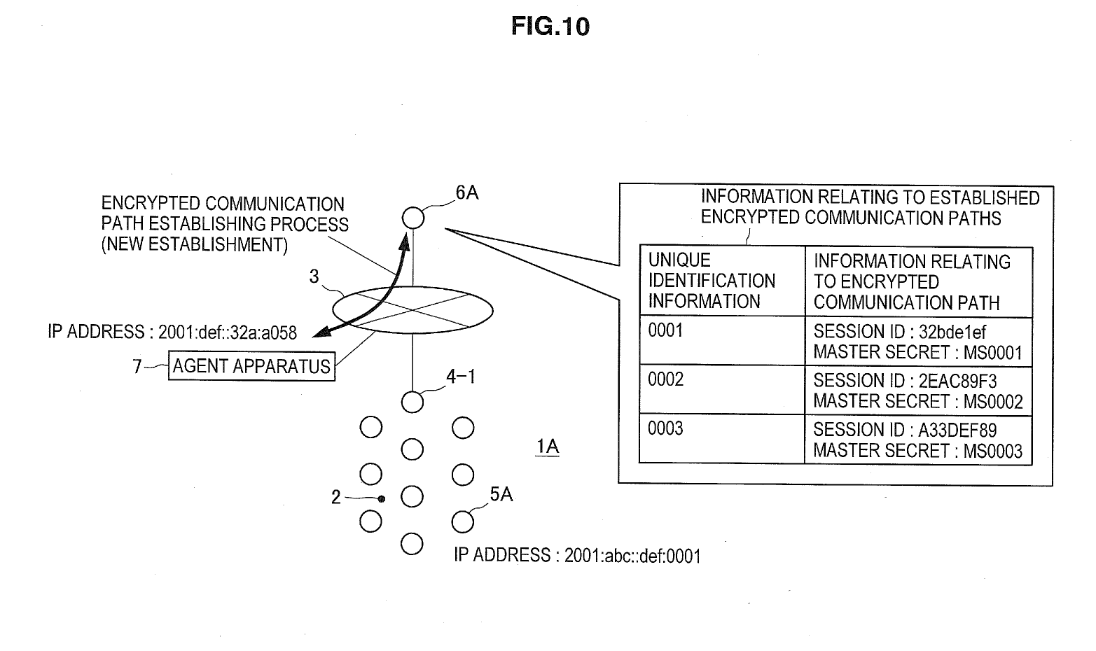

First, a new establishment operation for an encrypted communication path between the first communication apparatus 5A and the second communication apparatus 6A will be described with reference to FIG. 10.

Note that it is assumed that the first communication apparatus 5A has joined the wired network 3 in advance via the first gateway apparatus 4-1 and has been assigned an IP address (for example, “2001:abc::def:0001”). It is also assumed that the agent apparatus 7 has been assigned an IP address (for example, “2001:def::32a:a058”).

When it becomes necessary to newly establish an encrypted communication path between the first communication apparatus 5A and the second communication apparatus 6A, the encrypted communication path establishing unit 71 of the agent apparatus 7 generates a new encrypted communication path establishment request to be sent to the second communication apparatus 6A and transmits the request via the transmission unit 73 to the second communication apparatus 6A. Here, the encrypted communication path establishing unit 71 may recognize the need to newly establish an encrypted communication path based on a request from the first communication apparatus 5A. Alternatively, on receiving notification or recognizing that the first communication apparatus 5A has been added to the multi-hop network 2, the encrypted communication path establishing unit 71 may interpret the addition of the first communication apparatus 5A to the multi-hop network 2 as a request for the new establishment of an encrypted communication path and therefore start processing.

After the encrypted communication path establishing unit 62 of the second communication apparatus 6A has received a new encrypted communication path establishment request, an encrypted communication path is newly established between the first communication apparatus 5A and the second communication apparatus 6A by having messages according to a specified protocol (TLS or IPsec) for establishing an encrypted communication path exchanged between the encrypted communication path establishing unit 62 of the second communication apparatus 6A and the encrypted communication path establishing unit 71 of the agent apparatus 7. Here, by notifying the encrypted communication path establishing unit 62 of the identification information unique to the first communication apparatus, the encrypted communication path establishing unit 71 of the agent apparatus 7 establishes an encrypted communication path for the first communication apparatus 5A. The identification information unique to the first communication apparatus may be stored in advance in the encrypted communication path establishing unit 71 of the agent apparatus 7, or in a system where the first communication apparatus 5A requests new establishment of an encrypted communication path, the identification information unique to the first communication apparatus may be included in such request information. Also, the agent apparatus 7 may acquire the identification information unique to the first communication apparatus by communicating with the first communication apparatus 5A at specified timing, such as before generation of a new encrypted communication path establishment request to be transmitted to the second communication apparatus 6A.

The established encrypted communication path managing unit 61 of the second communication apparatus 6A manages information relating to the encrypted communication path established with the first communication apparatus 5A in association with the identification information unique to the first communication apparatus. Out of the information relating to the established encrypted communication paths in FIG. 10, the session ID “32bde1ef” and the master secret “MS0001” corresponding to the unique identification information “0001” are managed from this timing onward. Meanwhile, the established encrypted communication path managing unit 51 of the first communication apparatus 5A does not manage any information relating to an established encrypted communication path at such timing.

### (B-2-2) Notification Operation for Information Relating to Established Encrypted Communication Path

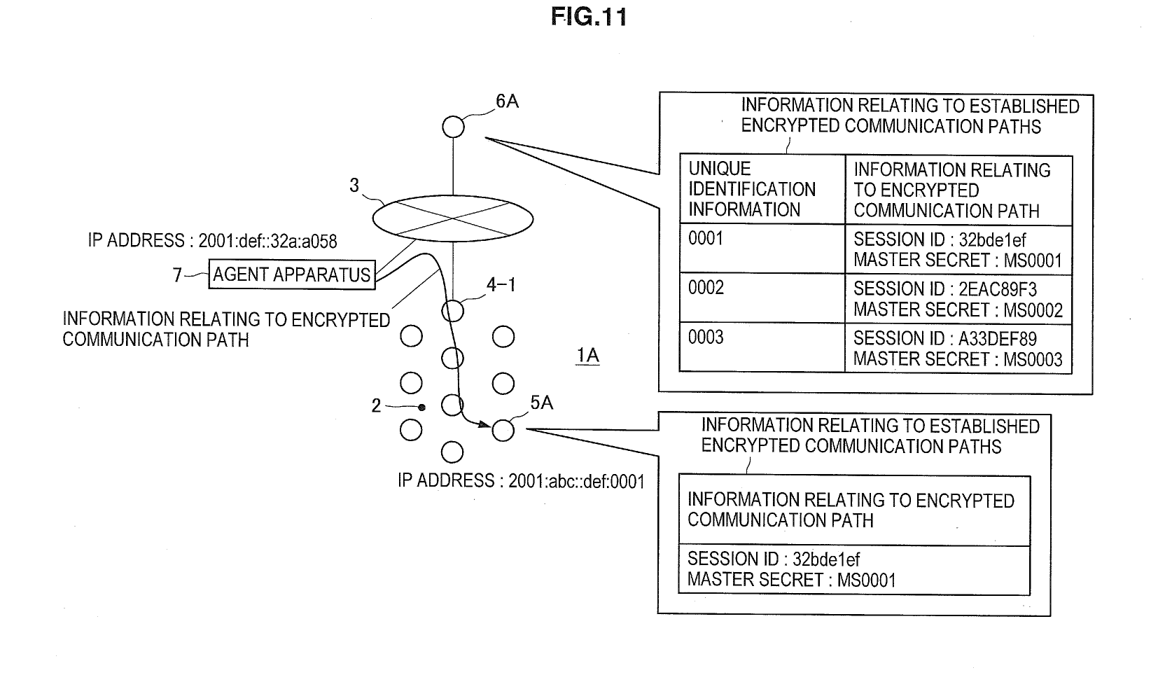

Next, the operation where the first communication apparatus 5A is given notification of information relating to an established encrypted communication path between the first communication apparatus 5A and the second communication apparatus 6A will be described with reference to FIG. 11.

When an encrypted communication path has been newly established between the first communication apparatus 5A and the second communication apparatus 6A by the agent apparatus 7 acting as an agent of the first communication apparatus 5A, the established encrypted communication path information notifying unit 72 of the agent apparatus 7 notifies the first communication apparatus 5A of information relating to the newly established encrypted communication path.

The established encrypted communication path information acquiring unit 55 of the first communication apparatus 5A acquires information relating to the newly established encrypted communication path notified from the agent apparatus 7 and has the established encrypted communication path managing unit 51 manage the acquired information relating to the encrypted communication path. By carrying out this process, as shown in FIG. 11, the first communication apparatus 5A manages the same information relating to the encrypted communication path (such as the session ID “32bde1ef” and the master secret “MS0001”) as the second communication apparatus 6A.

Although an example where the agent apparatus 7 gives notification of information relating to the newly established encrypted communication path to the first communication apparatus 5A is shown in FIG. 11, the second communication apparatus 6A may give the first communication apparatus 5A notification of information relating to the newly established encrypted communication path.

### (B-2-3) Reestablishment Operation for an Encrypted Communication Path

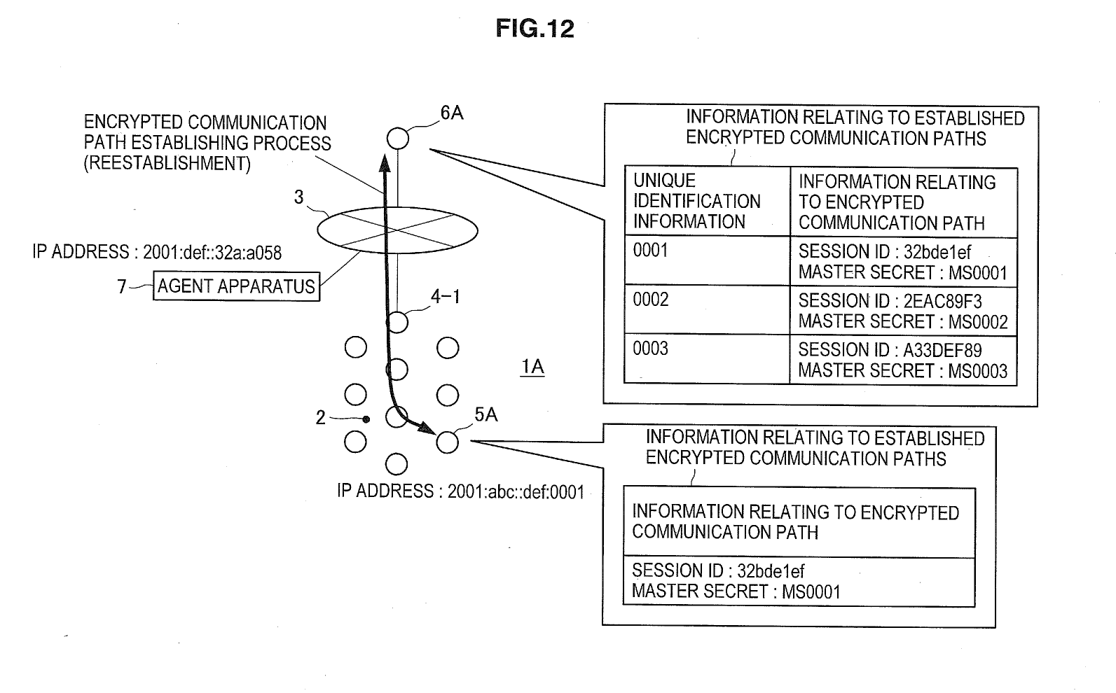

Next, an operation that reestablishes an encrypted communication path between the first communication apparatus 5A and the second communication apparatus 6A will be described with reference to FIG. 12.

In this second embodiment, although the agent apparatus 7 carries out an establishment operation as an agent of the first communication apparatus 5 when an encrypted communication path is newly established, when an encrypted communication path is reestablished, the first communication apparatus 5A carries out the reestablishment operation without using the agent apparatus 7.

This means that the reestablishment operation for an encrypted communication path between the first communication apparatus 5A and the second communication apparatus 6A is the same as the reestablishment operation in the first embodiment (see FIG. 5). That is, when reestablishment of an encrypted communication path becomes necessary, the first communication apparatus 5A switches the gateway apparatus to which the first communication apparatus 5A connects from the first gateway apparatus 4-1 to the second gateway apparatus 4-2 (step S100). The first communication apparatus 5A connects to the wired network 3 via the second gateway apparatus 4-2 and acquires an IP address (step S101), and then acquires information relating to an already established encrypted communication path from the established encrypted communication path managing unit 51 (step S102). The first communication apparatus 5A generates a reestablishment request for an encrypted communication path to the second communication apparatus 6A that includes the identification information unique to the first communication apparatus and information relating to the encrypted communication path already established with the second communication apparatus 6A, and transmits such reestablishment request via the transmission unit 53 to the second communication apparatus 6A (step S103). Based on the identification information unique to the first communication apparatus included in the reestablishment request for an encrypted communication path, the second communication apparatus 6A acquires information relating to an established encrypted communication path managed in association with the identification information unique to the first communication apparatus and confirms that the received information relating to an encrypted communication path matches the acquired information relating to an encrypted communication path (step S104). The encrypted communication path establishing unit 62 of the second communication apparatus 6A and the encrypted communication path establishing unit 52 of the first communication apparatus 5A then carry out the reestablishment process for an encrypted communication path (step S105).

Note that in a case where the encrypted communication path establishing unit 62 of the second communication apparatus 6A is unable to confirm that the received information relating to an encrypted communication path matches the information relating to an encrypted communication path acquired from the established encrypted communication path managing unit 61, the encrypted communication path establishing unit 62 of the second communication apparatus 6A notifies the encrypted communication path establishing unit 52 of the first communication apparatus 5A and on receiving such notification, the first communication apparatus 5A requests the agent apparatus 7 to newly establish an encrypted communication path.

### (B-3) Effect of Second Embodiment

According to the second embodiment, by having the second communication apparatus 6A manage the identification information unique to a first communication apparatus in association with information relating to an encrypted communication path already established with the agent apparatus 7 that establishes an encrypted communication path as an agent of the first communication apparatus 5A, it is possible to use information, which relates to the encrypted communication path that has already been established between the first communication apparatus 5A and the second communication apparatus 6A and is fetched based on the identification information unique to the first communication apparatus, to reestablish an encrypted communication path with less processing than when the first communication apparatus 5A newly establishes an encrypted communication path with the second communication apparatus 6A. That is, even when the first communication apparatus 5A has requested the agent apparatus 7 (for example, a server in the cloud) which is on a network but is not present on a path to the second communication apparatus 6A to establish an encrypted communication path, it is possible, based on the identification information unique to the first communication apparatus, to use information relating to an encrypted communication path that has already been established between the agent apparatus 7 and the second communication apparatus 6A to reestablish an encrypted communication path with less processing than when the first communication apparatus 5A newly establishes an encrypted communication path with the second communication apparatus 6A.

Using information relating to an already-established encrypted communication path as described above to reduce the amount of communication necessary to establish an encrypted communication path is extremely advantageous for a low-power multi-hop network. As one example, when the number of sensor apparatuses that form a low-power multi-hop network is extremely large, if it is desirable for each sensor apparatus to establish an encrypted communication path with a server on the Internet, there are concerns such as congestion on the low-power multi-hop network, an increase in power consumption, and an increase in processing time. With the second embodiment, it is possible to locate an apparatus that establishes an encrypted communication path as an agent for a sensor apparatus outside the low-power multi-hop network. As one example, it is also possible to provide resources for establishing an encrypted communication path as an agent in a cloud server located outside the low-power multi-hop network and to provide a flexible agent system that can respond to changes in the scale of the network and/or the processing load.

### (C) Other Embodiments

Although various modifications have been suggested in the above description of the embodiments, the following modifications can also be given as further examples.

In the embodiments described above, although an example has been described where the first communication apparatus 5 or the agent apparatus 7 is the initiator (or client) in the establishment of an encrypted communication path and the second communication apparatus 6, 6A is a responder (or server) in the establishment of an encrypted communication path, the present invention is not limited to this configuration. It is also possible to apply the technical concept of the present invention in a case where the second communication apparatus 6, 6A is the initiator (or client) in the establishment of an encrypted communication path and the first communication apparatus 5 or the agent apparatus 7 is the responder (or server) in the establishment of an encrypted communication path.

Although a case where the address on the network of the second communication apparatus 6, 6A to which the first communication apparatus 5, 5A wishes to establish an encrypted communication path does not change is described in the above embodiments, the present invention is not limited to such. As one example, it is possible to apply the present invention to a case where the address on the network of the second communication apparatus 6, 6A changes in the same way as the first communication apparatus 5, 5A. In such case, as one example, the established encrypted communication path managing unit 51 of the first communication apparatus 5, 5A manages the identification information that is unique to the second communication apparatus 6, 6A and manages information relating to an encrypted communication path that has already been established in association with the identification information unique to the second communication apparatus 6, 6A. By doing so, even when the address on the network of the second communication apparatus 6, 6A has changed, it is possible for the first communication apparatus 5, 5A to enquire into the address on the network of the second communication apparatus 6, 6A and to reestablish an encrypted communication path with the second communication apparatus 6, 6A.

Although an example where the agent apparatus 7 does not function when reestablishing an encrypted communication path was described above in the second embodiment, during reestablishment of an encrypted communication path also, the agent apparatus 7 may operate as an agent of the first communication apparatus 5A. In such case, the agent apparatus 7 may internally manage information relating to the encrypted communication path established for the first communication apparatus 5A and use such information in a reestablishment operation or may acquire information relating to the established encrypted communication path from the first communication apparatus 5A when reestablishment is requested and use such information in a reestablishment operation. If the agent apparatus 7 also operates as an agent of the first communication apparatus 5A during reestablishment of an encrypted communication path, although the functions of the first communication apparatus 5A can be simplified compared to the second embodiment, the functions of the agent apparatus 7 become more complex.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A secure communication system comprising a first communication apparatus and a second communication apparatus that carry out encrypted communication,
wherein the first communication apparatus includes:
a first established encrypted communication path managing unit managing information relating to an encrypted communication path that has been established with the second communication apparatus; and
a first encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path, and
the second communication apparatus includes:
a second established encrypted communication path managing unit managing the identification information unique to the first communication apparatus and managing the information relating to the established encrypted communication path in association with the identification information unique to the first communication apparatus; and
a second encrypted communication path reestablishing unit reestablishing the encrypted communication path with the first communication apparatus based on the identification information unique to the first communication apparatus and the information relating to the established encrypted communication path.

2. A secure communication system according to claim 1,
wherein the first established encrypted communication path managing unit manages identification information unique to the second communication apparatus and manages the information relating to the established encrypted communication path in association with the identification information unique to the second communication apparatus.

3. A secure communication system comprising:
a first communication apparatus and a second communication apparatus that carry out encrypted communication; and
a third communication apparatus that carries out a new establishment process for an encrypted communication path between the first communication apparatus and the second communication apparatus, as an agent of the first communication apparatus,
wherein the first communication apparatus includes:
an established encrypted communication path information acquiring unit acquiring, from the third communication apparatus, information relating to an established encrypted communication path between the first communication apparatus and the second communication apparatus, already established by the third communication apparatus operating in cooperation with the second communication apparatus;
a first established encrypted communication path managing unit managing the information relating to the established encrypted communication path acquired by the established encrypted communication path information acquiring unit; and
a first encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path,
the second communication apparatus includes:
a second established encrypted communication path managing unit managing information unique to the first communication apparatus that communicates with the second communication apparatus and managing information relating to the established encrypted communication path in association with the identification information unique to the first communication apparatus; and
a second encrypted communication path reestablishing unit reestablishing the encrypted communication path with the first communication apparatus based on the identification information unique to the first communication apparatus and the information relating to the established encrypted communication path, and
the third communication apparatus includes:
an encrypted communication path establishment agent unit establishing the encrypted communication path between the first communication apparatus and the second communication apparatus as an agent of the first communication apparatus, including giving notification of the identification information unique to the first communication apparatus; and
an established encrypted communication path information notifying unit giving notification to the first communication apparatus of information relating to the established encrypted communication path.

4. A secure communication system according to claim 3,
wherein the first established encrypted communication path managing unit manages identification information unique to the second communication apparatus and manages the information relating to the established encrypted communication path acquired by the established encrypted communication path information acquiring unit in association with the identification information unique to the second communication apparatus.

5. A secure communication system comprising:
a first communication apparatus and a second communication apparatus that carry out encrypted communication; and
a third communication apparatus that carries out a new establishment process for an encrypted communication path between the first communication apparatus and the second communication apparatus, as an agent of the first communication apparatus,
wherein the first communication apparatus includes:
an established encrypted communication path information acquiring unit acquiring, from the third communication apparatus, information relating to an established encrypted communication path between the first communication apparatus and the second communication apparatus, already established by the third communication apparatus operating in cooperation with the second communication apparatus; and
a first established encrypted communication path managing unit managing the information relating to the established encrypted communication path acquired by the established encrypted communication path information acquiring unit;
the third communication apparatus includes:
a first encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path,
the second communication apparatus includes:
a second established encrypted communication path managing unit managing information unique to the first communication apparatus that communicates with the second communication apparatus and managing information relating to the established encrypted communication path in association with the identification information unique to the first communication apparatus; and
a second encrypted communication path reestablishing unit reestablishing the encrypted communication path with the first communication apparatus based on the identification information unique to the first communication apparatus and the information relating to the established encrypted communication path, and
the third communication apparatus further includes:
an encrypted communication path establishment agent unit establishing the encrypted communication path between the first communication apparatus and the second communication apparatus as an agent of the first communication apparatus, including giving notification of the identification information unique to the first communication apparatus; and
an established encrypted communication path information notifying unit giving notification to the first communication apparatus of information relating to the established encrypted communication path.

6. A communication apparatus carrying out encrypted communication via an encrypted communication path with another communication apparatus, comprising:
an established encrypted communication path managing unit managing identification information unique to the other communication apparatus and managing information relating to an established encrypted communication path in association with the identification information unique to the other communication apparatus; and
an encrypted communication path reestablishing unit reestablishing an encrypted communication path with the other communication apparatus based on the identification information unique to the other communication apparatus and the information relating to the established encrypted communication path.

7. A first communication apparatus in a secure communication system including the first communication apparatus and a second communication apparatus that carry out encrypted communication, the system also including a third communication apparatus carrying out a new establishment process for an encrypted communication path between the first communication apparatus and the second communication apparatus as an agent of the first communication apparatus,
the first communication apparatus comprising:
an established encrypted communication path information acquiring unit acquiring, from the third communication apparatus, information relating to an established encrypted communication path between the first communication apparatus and the second communication apparatus, already established by the third communication apparatus operating in cooperation with the second communication apparatus;
an established encrypted communication path managing unit managing the information relating to the established encrypted communication path acquired by the established encrypted communication path information acquiring unit; and
an encrypted communication path reestablishing unit notifying the second communication apparatus of identification information unique to the first communication apparatus and operating in cooperation with the second communication apparatus to reestablish an encrypted communication path with the second communication apparatus using the information relating to the established encrypted communication path.

8. A third communication apparatus in a secure communication system including the first communication apparatus and a second communication apparatus that carry out encrypted communication, where the third communication apparatus carries out a new establishment process for an encrypted communication path between the first communication apparatus and the second communication apparatus, as an agent of the first communication apparatus,
the third communication apparatus comprising:
an encrypted communication path establishment agent unit establishing an encrypted communication path between the first communication apparatus and the second communication apparatus as an agent of the first communication apparatus, including giving notification of identification information unique to the first communication apparatus; and
an established encrypted communication path information notifying unit giving notification to the first communication apparatus of information relating to the established encrypted communication path.
